(19) United States
(12) Patent Application Publication
(10) Pub. No.: US 2026/0020093 A1
(43) Pub. Date: Jan. 15, 2026

(54) CONNECTION CONTROL DEVICE, CONNECTION CONTROL SYSTEM, AND NON-TRANSITORY COMPUTER-READABLE MEDIUM STORING PROGRAM

(71) Applicant: FANUC CORPORATION, Minamitsuru-gun, Yamanashi (JP)

(72) Inventor: Kouji SEKIMOTO, Yamanashi (JP)

(21) Appl. No.: 18/993,835

(22) PCT Filed: Jul. 25, 2022
(86) PCT No.: PCT/JP2022/028585

§ 371 Date: Jan. 13, 2025

(51) Int. Cl. H04W 76/18

(52) U.S. Cl. CPC H04W 76/18

(57) ABSTRACT

A connection control device according to an embodiment comprises a determination unit and a connection control unit. The determination unit determines whether a first device is a device of a first type among a plurality of types. When the connection control unit has received a request from the first device to connect with a second device, if the first device is not a device of the first type, the connection control unit allows the connection with the second device if there is a number of spaces greater than or equal to (N+1-(number of first devices of the first type that have established a connection with the second device)) among the number of possible connections (where N is an integer greater than or equal to 1), and refuses the connection with the second device if this is not the case.

### TECHNICAL FIELD

The present invention relates to a connection control device, a connection control system, and a program.

### BACKGROUND ART

Among devices such as control devices for controlling industrial machinery, there are devices that connect with a plurality of display devices, including a main display device used primarily and auxiliary display devices used secondarily. In such devices, there is a technique to limit the number of connectable display devices to avoid excessive consumption of resources such as processors like CPUs (central processing units). A plurality of display devices are used.

### CITATION LIST

### Patent Document

Patent Document 1: Japanese Unexamined Patent Application, Publication No. 2015-128476

### DISCLOSURE OF THE INVENTION

### Problems to be Solved by the Invention

However, in such devices, simply limiting the number of connections may prevent the main display device from connecting when the number of connections is already at the limit due to the auxiliary display devices.

The problem that the embodiments of the present invention aims to solve is to provide a connection control device, a connection control system, and a program, which are capable of guaranteeing the connection of predetermined types of devices.

### Means for Solving the Problems

The connection control device of the embodiment includes a determination unit and a connection control unit. The determination unit determines that a first device is a device of a first type among a plurality of types. In a case where a connection request from the first device to the second device is received, and the first device is not a device of the first type, the connection control unit permits the connection with the second device if there are (N (where N is an integer of 1 or more)+1-(the number of the first devices of the first type that have established connections with the second device)) or more available connections, or the connection control unit rejects the connection with the second device if this is not the case.

### Effects of the Invention

The present invention can guarantee the connection of predetermined types of devices.

### BRIEF DESCRIPTION OF THE DRAWINGS

FIG. 1 is a block diagram illustrating an example of the main configuration of a display system according to the first embodiment and components included in the display system;

FIG. 2 is a flowchart illustrating an example of the processing by the processor of the control device in FIG. 1, according to the first embodiment;

FIG. 3 is a flowchart illustrating an example of the processing by the processor of the display device in FIG. 1 or the auxiliary display device in FIG. 4, according to the first and second embodiments;

FIG. 4 is a block diagram illustrating an example of the main configuration of a display system according to the second embodiment and components included in the display system;

FIG. 5 is a flowchart illustrating an example of the processing by the processor of the control device in FIG. 4, according to the second embodiment; and

FIG. 6 is a flowchart illustrating an example of the processing by the processor of the main display device in FIG. 4, according to the second embodiment.

### PREFERRED MODE FOR CARRYING OUT THE INVENTION

Hereinafter, the display system according to some embodiments will be described with reference to the drawings. In each drawing used to describe the embodiments, the scale of each part may be changed as appropriate. Each drawing used to describe the embodiments may show an abbreviated configuration for the purpose of explanation. In the drawings and this specification, the same reference numerals denote the same elements.

### First Embodiment

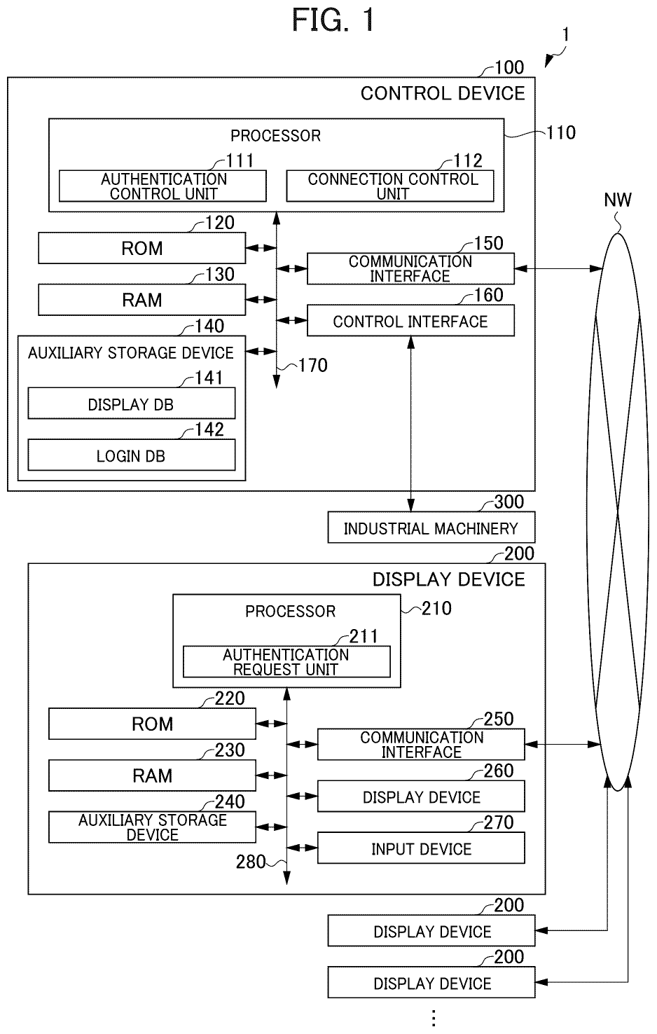

FIG. 1 is a block diagram illustrating an example of the main configuration of a display system 1 according to the first embodiment and components included in the display system 1. The display system 1 is a system capable of controlling the connection between a control device 100 and a plurality of display devices 200. The display system 1 includes, for example, the control device 100, the display devices 200, and industrial machinery 300. The number of devices included in the display system 1 is not limited. The display system 1 typically includes the plurality of display devices 200. The display system 1 is an example of the connection control system.

The control device 100, the display devices 200, and the industrial machinery 300 are connected to a network NW. The network NW typically includes a communication network including a private network such as an intranet. The network NW typically includes a communication network such as a LAN (local area network). The network NW may be a communication network including the Internet. The network NW may be a communication network including a WAN (wide area network). The network NW may be a wireless line, a wired line, or a mixture of wireless and wired lines. The network NW may be a communication network including a dedicated line or a public mobile phone network. Each device connected to the network NW typically communicates using TCP (Transmission Control Protocol)/IP (Internet Protocol).

The control device 100 is a device that controls the industrial machinery 300 or the like. The control device 100 can establish connections with the display devices 200 up to the connection limit. The control device 100 transmits video to each of the connected display devices 200. Establishing a connection means establishing a session, establishing a connection, or the like. The control device 100 includes, for example, a processor 110, a ROM (read-only memory) 120, a RAM (random-access memory) 130, an auxiliary storage device 140, a communication interface 150, and a control interface 160. A bus 170 or the like connects these components. In the first embodiment, the control device 100 is an example of the connection control device. The control device 100 is an example of the second device.

The processor 110 is the central part of a computer that executes calculations and control necessary for the operation of the control device 100, executing various calculations and processing. The processor 110 includes, for example, CPU, MPU (micro processing unit), SoC (system on a chip), DSP (digital signal processor), GPU (graphics processing unit), ASIC (application specific integrated circuit), PLD (programmable logic device) or FPGA (field-programmable gate array), or the like. Alternatively, the processor 110 may be a combination of a plurality of these components. The processor 110 may be a combination of these components with hardware accelerators or the like. The processor 110 controls various functions of the control device 100, based on programs such as firmware, system software, and application software stored in the ROM 120 or the auxiliary storage device 140. The processor 110 executes the processing described later, based on the programs. Part or all of the programs may be incorporated into the circuit of the processor 110.

The ROM 120 and RAM 130 are the main memory devices of the computer, centered around the processor 110. The ROM 120 is non-volatile memory used exclusively for reading data. The ROM 120 stores, for example, firmware among the aforementioned programs. The ROM 120 also stores data used by the processor 110 in executing various processing. The RAM 130 is memory used for reading and writing data. The RAM 130 is used as a work area to temporarily store data used by the processor 110 in executing various processing. The RAM 130 is typically volatile memory.

The processor 110 functions as an authentication control unit 111 and a connection control unit 112, based on the aforementioned programs. The authentication control unit 111 controls authentication. Details of the authentication will be described later. The connection control unit 112 controls the connection between the control device 100 and the display devices 200.

The auxiliary storage device 140 is the auxiliary storage device of the computer, centered around the processor 110. The auxiliary storage device 140 includes, for example, EEPROM (electric erasable programmable read-only memory), HDD (hard disk drive), or flash memory. The auxiliary storage device 140 stores, for example, system software and application software among the aforementioned programs. The auxiliary storage device 140 stores data used by the processor 110 in executing various processing, data generated by the processing in the processor 110, and various setting values.

The auxiliary storage device 140 stores a display database (DB) 141 and a login database (DB) 142. The display DB 141 stores and manages whether each display device 200 is a main display device 200A or an auxiliary display device 200B. The main display device 200A is, for example, a display device 200 used primarily. The main display device 200A is, for example, a primary display device 200. The auxiliary display device 200B is, for example, a display device 200 other than the main display device 200A. The auxiliary display device 200B is, for example, a display device 200 used secondarily. The auxiliary display device 200B is, for example, a display device 200 used remotely with the control device 100. The display DB 141 stores whether each display device 200 is a main display device 200A or an auxiliary display device 200B by associating classification information with the display ID (identifier) of each display device 200. The display ID is unique identification information for each display device 200. The classification information indicates whether the associated display device 200 is a main display device 200A or an auxiliary display device 200B. The number of display devices 200 that can be registered as main display devices 200A in the display DB 141 is usually one. However, the display DB 141 may allow the upper limit to be two or more, or unlimited. The processor 110 controls so that the number of main display devices 200A registered in the display DB 141 does not exceed the upper limit. Whether each display device 200 is a main display device 200A or an auxiliary display device 200B is pre-registered in the display DB 141 by, for example, the administrator or operator of the display system 1.

The display ID is, for example, the IP address, MAC (media access control) address, or other unique number for each of other display devices 200. The display ID may also be a login ID. The login ID is unique identification information for each account used to log in to the control device 100. The account and login ID may be unique for each display device 200 or for each user. The user is, for example, a person who uses the display device 200. When the account and login ID are unique for each user, the display device 200 is determined as a main display device 200A or an auxiliary display device 200B depending on the user who logs in.

The login DB 142 stores and manages information necessary for the authentication processing to determine whether an account can log in to the control device 100. The login DB 142 stores combinations of login IDs and passwords by associating login IDs with passwords for each account.

The communication interface 150 is an interface for the control device 100 to communicate through the network NW or the like. The control device 100 communicates with the display device 200 via the communication interface 150 and the network NW. The communication interface 150 connects to the network NW using, for example, a LAN cable or wireless LAN.

The communication interface 150 may connect and communicate directly with the display device 200 without using the network NW. This communication may be either wired or wireless. The communication interface 150 may connect and communicate with the display device 200 using video communication interfaces such as DisplayPort, HDMI (High-Definition Multimedia Interface) (registered trademark), DVI (Digital Visual Interface), or SDI (serial digital interface). The communication interface 150 may connect and communicate with the display device 200 using a general-purpose communication interface such as USB (universal serial bus). The communication interface 150 may connect and communicate with the display device 200 using other standards.

The control interface 160 is an interface for the control device 100 to communicate with the industrial machinery 300. The control device 100 controls the industrial machinery 300 via the control interface 160. The control interface 160 may be shared with the communication interface 150.

The bus 170 includes a control bus, address bus, and data bus, or the like, and transmits signals exchanged between the various components of the control device 100.

The display device 200 receives input of video signals output by the control device 100. The display device 100 displays the video represented by the video signals. The display device 200 includes, for example, a display such as an LCD (liquid crystal display) or an OEL (organic electro-luminescence) display. The display device 200 may be a smartphone, tablet terminal, PC, or server device. The display device 200 includes, for example, a processor 210, ROM 220, RAM 230, auxiliary storage device 240, communication interface 250, display device 260, and input device 270. The bus 280 or the like connects these components. The display device 200 is an example of the first device. The main control device 100A is an example of the first type of the first device.

The processor 210 is the central part of a computer that executes calculations and controls necessary for the operation of the display device 200, executing various calculations and processing. The processor 210 includes, for example, CPU, MPU, SoC, DSP, GPU, ASIC, PLD, or FPGA. Alternatively, the processor 210 may be a combination of a plurality of these components. The processor 210 may also include a combination of these components with hardware accelerators or the like. The processor 210 controls various functions of the display device 200, based on programs such as firmware, system software, and application software stored in the ROM 220 or auxiliary storage device 240. The processor 210 executes the processing described later, based on these programs. Part or all of the programs may be incorporated into the circuit of the processor 210.

The ROM 220 and RAM 230 are the main memory devices of the computer, centered around the processor 210. The ROM 220 is non-volatile memory used exclusively for reading data. The ROM 220 stores, for example, firmware among the aforementioned programs. The ROM 220 also stores data used by the processor 210 in executing various processing. The RAM 230 is memory used for reading and writing data. The RAM 230 is used as a work area to temporarily store data used by the processor 210 in executing various processing. The RAM 230 is typically volatile memory.

The processor 210 functions as an authentication request unit 211, based on the aforementioned programs. The authentication request unit 211 makes requests for connections and authentication. Details of the authentication will be described later.

The auxiliary storage device 240 is the auxiliary storage device of the computer, centered around the processor 210. The auxiliary storage device 240 includes, for example, EEPROM, HDD, or flash memory. The auxiliary storage device 240 stores, for example, system software and application software among the aforementioned programs. The auxiliary storage device 240 stores data used by the processor 210 in executing various processing, data generated by processing in the processor 210, and various setting values.

The ROM 220, the RAM 230, or the auxiliary storage device 240 stores the display ID of the display device 200 that includes these components. This storage may be temporary or non-temporary.

The communication interface 250 is an interface for the display device 200 to communicate through the network NW or the like.

The display device 260 displays screens to notify various information to operators of the display device 200. The display device 260 includes, for example, a display such as an LCD (liquid crystal display) or an OEL (organic electro-luminescence) display. The display device 260 may be built into the display device 200 or may be external. The display device 260 is an example of the display unit for displaying video.

The input device 270 receives operations from operators of the display device 200. The input device 270 includes, for example, a keyboard, keypad, touchpad, mouse, or controller. The input device 270 may be a device for voice input. A touch panel can also be used as the display device 200 and the input device 270. In this case, the display panel of the touch panel functions as the display device 200. The pointing device used for touch input, included in the touch panel, functions as the input device 270.

The bus 280 includes a control bus, address bus, and data bus, or the like, and transmits signals exchanged between the various components of the display device 200.

The industrial machinery 300 includes, for example, machine tools, manipulators, robot arms, or robots.

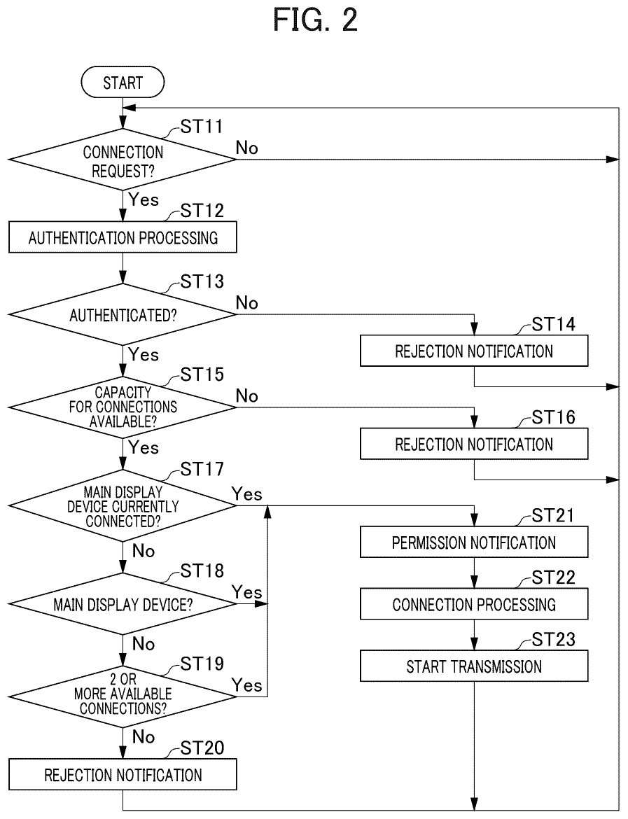

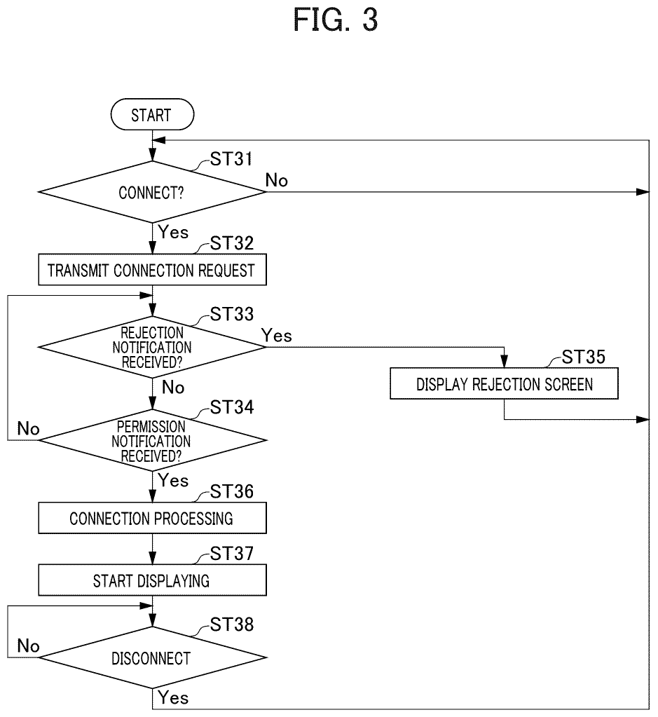

Next, the operation of the display system 1 according to the first embodiment will be described with reference to FIGS. 2 and 3. The details of the processing described in the following operation are examples, and various processing capable of obtaining similar results can be used as appropriate. FIG. 2 is a flowchart illustrating an example of the processing by the processor 110 of the control device 100. The processor 110 executes the processing illustrated in FIG. 2, based on the programs stored in the ROM 120, the auxiliary storage device 140, or the like. FIG. 3 is a flowchart illustrating an example of the processing by the processor 210 of the display device 200. The processor 210 executes the processing illustrated in FIG. 3, based on the programs stored in the ROM 220, the auxiliary storage device 240, or the like.

In Step ST31 illustrated in FIG. 3, the processor 210 of the display device 200 determines whether to execute the connection to the control device 100. For example, if an input instructing to execute the connection is received, the processor 210 determines to execute the connection. This input is, for example, an operational input to the input device 270 by the operator of the display device 200. Alternatively, if information instructing to execute the connection is received from another device, the processor 210 determines to execute the connection. Alternatively, in a state where communication with the control device 100 is possible, the processor 210 may determine to execute the connection to the control device 100. If the processor 210 determines not to execute the connection to the control device 100, the determination in Step ST31 is No, and the processing in Step ST31 is repeated. On the other hand, if the processor 210 determines to execute the connection to the control device 100, the determination in Step ST31 is Yes, and the processing proceeds to Step ST32.

The processor 210 may skip the processing in Step ST31 and proceed to Step ST32. That is, if the control device 100 is not connected while executing the processing illustrated in FIG. 3, the processor 210 may automatically execute the connection to the control device 100.

In Step ST32, the processor 210 generates the first connection request. The first connection request includes, for example, a display ID, login ID, and password. The first connection request is information that requests the control device 100 to execute authentication using the login ID and the password. The first connection request is information that requests the recipient to establish connections with the display device 200 that is the source of the first connection request. The display ID is the display ID stored in the ROM 220, the RAM 230, or the auxiliary storage device 240. That is, the display ID included in the first connection request is the display ID of the display device 200 that is the source of the first connection request. The login ID and password are input, for example, by the operator of the display device 200 via the input device 270. Alternatively, the processor 210 may obtain at least one of the login ID or password from the auxiliary storage device 240. In this case, the auxiliary storage device 240 stores at least one of the login ID or password in advance. When using the login ID as the display ID, the display ID and login ID may be the same. After generating the first connection request, the processor 210 instructs the communication interface 250 to transmit the first connection request to the control device 100. Upon receiving the transmission instruction, the communication interface 250 transmits the first connection request to the control device 100. The transmitted first connection request is received by the communication interface 150 of the control device 100. The processing in Step ST32 is executed, for example, by the authentication request unit 211.

Meanwhile, in Step ST11 illustrated in FIG. 2, the processor 110 of the control device 100 waits for the first connection request to be received by the communication interface 150. When the first connection request is received, the processor 110 determines Yes in Step ST11, and the processing proceeds to Step ST12.

In Step ST12, the processor 110 executes the authentication processing using the login ID and password included in the first connection request received in Step ST11. That is, if the combination of the login ID and password is correct, the processor 110 executes authentication. Conversely, if the combination of the login ID and password is incorrect, the processor 110 rejects authentication.

The processor 110 refers to the login DB 142 to check whether the login ID included in the first connection request received in Step ST11 is stored in the login DB 142. If the login ID is stored in the login DB 142, the processor 110 refers to the login DB 142 to check whether the password included in the first connection request is associated with the login ID. If the password is associated with the login ID in the login DB 142, the processor 110 determines that the combination of the login ID and password is correct.

Conversely, if the login ID included in the first connection request received in Step ST11 is not stored in the login DB 142, the processor 110 determines that the combination of the login ID and password is incorrect. Similarly, if the password included in the first connection request is not associated with the login ID included in the first connection request in the login DB 142, the processor 110 determines that the combination of the login ID and password is incorrect. The processing in Step ST12 is executed, for example, by the authentication control unit 111.

In Step ST13, the processor 110 determines whether authentication was executed in the authentication processing in Step ST12. If authentication was rejected, the processor 110 determines No in Step ST13, and the processing proceeds to Step ST14.

In Step ST14, the processor 110 instructs the communication interface 150 to transmit a first rejection notification to the display device 200 that is the source of the first connection request. The first rejection notification is information indicating that authentication was rejected in the authentication processing. Upon receiving the transmission instruction, the communication interface 150 transmits the first rejection notification to the display device 200. The transmitted first rejection notification is received by the communication interface 250 of the display device 200. After the processor 110 executes the processing in Step ST14, the processing returns to Step ST11.

Conversely, if authentication was executed in the authentication processing, the processor 110 determines Yes in Step ST13, and the processing proceeds to Step ST15.

In Step ST15, the processor 110 determines whether there is available capacity for connections. If the number of display devices 200 that have established connections with the control device 100 is less than the connection limit, the processor 110 determines that there is available capacity for connections. If there is no available capacity for connections, the processor 110 determines No in Step ST15, and the processing proceeds to Step ST16.

In Step ST16, the processor 110 instructs the communication interface 150 to transmit a second rejection notification to the display device 200 that is the source of the first connection request. The second rejection notification is information indicating that there is no available capacity for connections. Upon receiving the transmission instruction, the communication interface 150 transmits the second rejection notification to the display device 200. The transmitted second rejection notification is received by the communication interface 250 of the display device 200. After the processor 110 executes the processing in Step ST16, the processing returns to Step ST11.

Conversely, if there is available capacity for connections, the processor 110 determines Yes in Step ST15, and the processing proceeds to Step ST17.

In Step ST17, the processor 110 determines whether the main display device 200A is currently connected. That is, the processor 110 determines whether at least one of the display devices 200 that have established connections with the control device 100 is the main display device 200A. If the main display device 200A is currently connected, the processor 110 determines Yes in Step ST17, and the processing proceeds to Step ST18.

In Step ST18 illustrated in FIG. 2, the processor 110 of the control device 100 determines whether the display device 200 that is the source of the first connection request is the main display device 200A. The processor 110 obtains the display ID included in the first connection request received in Step ST11. The processor 110 then refers to the display DB 141 to obtain the classification information associated with the display ID. If the classification information indicates that the display device 200 is the main display device 200A, the processor 110 determines that the display device 200 that is the source of the first connection request is the main display device 200A. Conversely, if the classification information indicates that the display device 200 is the auxiliary display device 200B, the processor 110 determines that the display device 200 that is the source of the first connection request is the auxiliary display device 200B. If the display device 200 that is the source of the first connection request is not the main display device 200A, the processor 110 determines No in Step ST18, and the processing proceeds to Step ST19.

As described above, by executing the processing in Step ST18, the processor 110 functions as an example of the determination unit that determines that the first device is a device of the first type among the plurality of types.

In Step ST19, the processor 110 determines whether the number of available connections is two or more. If the number of available connections is one or less, the processor 110 determines No in Step ST19, and the processing proceeds to Step ST20.

In Step ST20, the processor 110 instructs the communication interface 150 to transmit a second rejection notification to the display device 200 that is the source of the first connection request. Alternatively, the processor 110 instructs the communication interface 150 to transmit a third rejection notification to the display device 200 that is the source of the first connection request. The third rejection notification is information indicating that although there is available capacity for connections, the connection is only allowed for the main display device 200A. Upon receiving the transmission instruction, the communication interface 150 transmits the second or third rejection notification to the display device 200. The transmitted second or third rejection notification is received by the communication interface 250 of the display device 200. After the processor 110 executes the processing in Step ST20, the processing returns to Step ST11.

Meanwhile, in Step ST33 illustrated in FIG. 3, the processor 210 of the display device 200 determines whether a rejection notification has been received by the communication interface 250. The rejection notification is a collective term for the first to third rejection notifications. If a rejection notification has not been received, the processor 210 determines No in Step ST33, and the processing proceeds to Step ST34.

In Step ST34, the processor 210 determines whether a permission notification has been received by the communication interface 250. If a permission notification has not been received, the processor 210 determines No in Step ST34, and the processing returns to Step ST33. Thus, the processor 210 remains in a waiting state, repeating Steps ST33 and ST34 until a rejection or permission notification is received.

If a rejection notification is received while the processor 210 is in the waiting state of Steps ST33 and ST34, the processor 210 determines Yes in Step ST33, and the processing proceeds to Step ST35.

In Step ST35, the processor 210 generates an image corresponding to the rejection screen. The processor 210 then instructs the display device 200 to display the generated image. Upon receiving the display instruction, the display device 200 displays the rejection screen.

The rejection screen is a screen that notifies the operator of the display device 200 that the display device 200 cannot establish the connection with the control device 100. The rejection screen includes, for example, an image indicating that the display device 200 cannot establish the connection with the control device 100, and an image indicating the reason why the connection cannot be established. Text is a type of image. If the received rejection notification is the first rejection notification, the reason why the connection cannot be established is that authentication was rejected. If the received rejection notification is the second rejection notification, the reason why the connection cannot be established is that there is no available capacity for connections. If the received rejection notification is the third rejection notification, the reason why the connection cannot be established is that although there is available capacity for connections, the connection cannot be established because the device is not the main display device 200A. After the processor 210 executes the processing in Step ST35, the processing returns to Step ST31.

Meanwhile, if the main display device 200A is not currently connected, the processor 110 of the control device 100 determines No in Step ST17 illustrated in FIG. 2, and the processing proceeds to Step ST11. If the display device 200 that is the source of the first connection request is the main display device 200A, the processor 110 determines Yes in Step ST18, and the processing proceeds to Step ST21. If the number of available connections is two or more, the processor 110 determines Yes in Step ST19, and the processing proceeds to Step ST21.

In Step ST21, the processor 110 instructs the communication interface 150 to transmit a permission notification to the display device 200 that is the source of the first connection request. The permission notification is information indicating that the connection with the control device 100 is permitted. Upon receiving the transmission instruction, the communication interface 150 transmits the permission notification to the display device 200. The transmitted permission notification is received by the communication interface 250 of the display device 200.

As described above, through the processing in Steps ST17 to ST21, if the main display device 200A is currently connected to the control device 100, and the number of available connections is one or more, the processor 110 permits the connection between the auxiliary display device 200B and the control device 100. If the main display device 200A is not currently connected to the control device 100, and the number of available connections is two or more, the processor 110 permits the connection between the auxiliary display device 200B and the control device 100. That is, if there are (2-(the number of the first devices of the first type that have established connections with the second device)) or more available connections, the processor 110 permits the connection between the auxiliary display device 200B and the control device 100. Therefore, by executing the processing in Steps ST17 to ST21, in a case where a connection request from the first device to the second device is received, and the first device is not a device of the first type, if there are (2-(the number of the first devices of the first type that have established connections with the second device)) or more available connections, the processor 110 functions as an example of the connection control unit that permits the connection with the second device, and rejects the connection with the second device if it is not the case.

Meanwhile, if a permission notification is received while the processor 210 is in the waiting state of Steps ST33 and ST34 illustrated in FIG. 3, the processor 210 determines Yes in Step ST34, and the processing proceeds to Step ST36.

In Step ST36, the processor 210 collaborates with the control device 100 to establish connections with the control device 100.

Meanwhile, in Step ST22 illustrated in FIG. 2, the processor 110 of the control device 100 collaborates with the display device 200 to establish connections with the display device 200. Thus, the processing in Step ST22 in FIG. 2 and Step ST36 in FIG. 3 establishes connections between the control device 100 and the display device 200. The processing in Steps ST15 to ST22 illustrated in FIG. 2 is executed, for example, by the connection control unit 112.

In Step ST23, the processor 110 starts transmitting video to the display device 200 using the established connection. The communication interface 150 transmits the video to the display device 200. The transmitted video is received by the communication interface 250 of the display device 200. After the processor 110 executes the processing in Step ST23, the processing returns to Step ST11.

As described above, by controlling the communication interface 150 to receive video, the processor 110 functions as an example of the receiving unit that collaborates with the communication interface 150 to receive video transmitted from the second device connected to the display device.

Meanwhile, in Step ST37 illustrated in FIG. 3, the processor 210 of the display device 200 controls the display device 260 to display the video received by the communication interface 250. Based on this control, the display device 260 starts displaying the video.

In Step ST38, the processor 210 waits for disconnection of the established connection with the control device 100. The cause of disconnection can be, for example, communication failure, timeout, or no operations. For example, if there is no operation for a predetermined period of time, i.e., if the time during which no operation is performed on the display device 200 continues for a predetermined period of time, the processor 110 of the control device 100 may disconnect the established communication with the display device 200.

If the established connection with the control device 100 is disconnected, the processor 210 determines Yes in Step ST38, and the processing returns to Step ST31. Alternatively, the processor 210 may attempt reconnection by returning to Step ST32, for example.

In a case where the display device 200 that requested the connection with the control device 100 is the auxiliary display device 200B, the display system 1 of the first embodiment rejects the connection unless there are (2-(the number of the main display devices 200A that have established connections with the control device 100)) or more available connections with the control device 100. As a result, the display system 1 of the first embodiment ensures that at least one main display device 200A can connect to the control device 100. In other words, the display system 1 of the first embodiment guarantees that a predetermined type of device, the main display device 200A, can connect to the control device 100.

According to the display system 1 of the first embodiment, the control device 100 controls the connection. As a result, the main display device 200A does not need to include special functions compared to the auxiliary display device 200B.

The first embodiment described above can be modified as follows. In the first embodiment, the control device 100 reserves one of the available connections for the main display device 200A. However, the control device 100 may reserve two or more of the available connections for the main display device 200A. Generalizing, the control device 100 reserves N of the available connections for the main display device 200A. In this case, in Step ST17, the processor 110 of the control device 100 determines whether N main display devices 200A are currently connected. In Step ST19, the processor 110 determines whether there are (N+1-(the number of the main display devices 200A that have established connections with the control device 100)) or more available connections. N is an integer of 1 or more.

Thus, in the display system 1 of the embodiment, if the display device 200 that requested the connection with the control device 100 is the auxiliary display device 200B, the connection is rejected unless there are (N+1-(the number of the main display devices 200A that have established connections with the control device 100)) or more available connections with the control device 100. As a result, the display system 1 of the embodiment ensures that N main display devices 200A can connect to the control device 100.

### Second Embodiment

In the display system 1b of the second embodiment, the main display device 200A controls the connection, instead of the control device 100. In the description of the second embodiment, the same portions as in the first embodiment may be omitted.

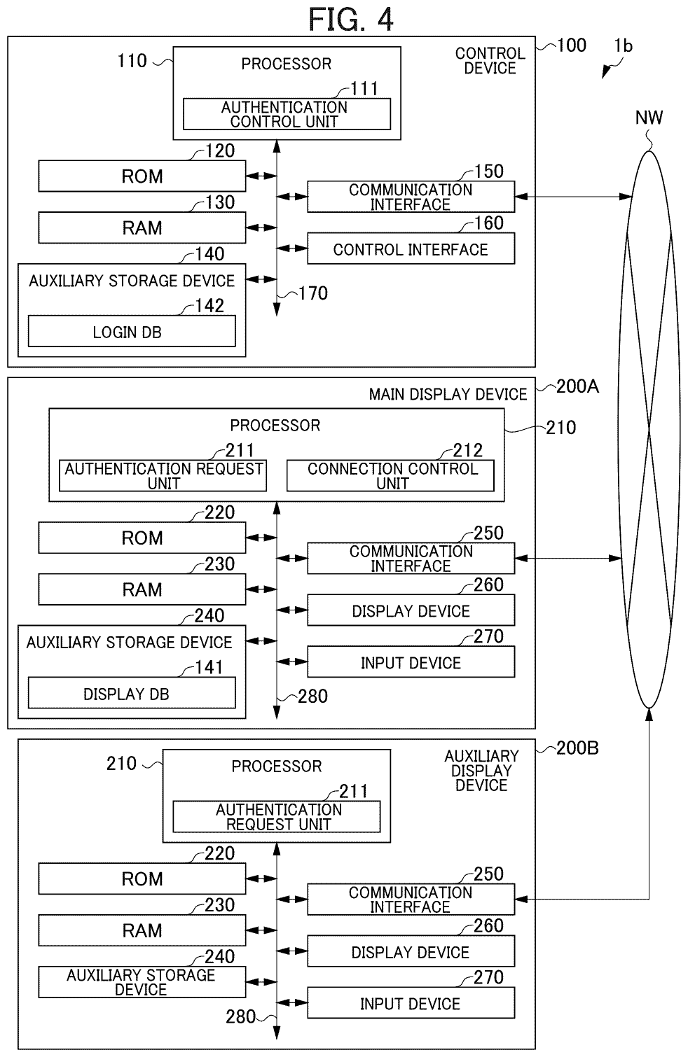

FIG. 4 is a block diagram illustrating an example of the main configuration of the display system 1b according to the second embodiment and components included in the display system 1b. In FIG. 4, illustration of the industrial machinery 300 is omitted. In FIG. 4, only one of each of the control device 100, the main display device 200A, and the auxiliary display device 200B is illustrated, but the number of each device is not limited. The display system 1b is an example of the connection control system.

The processor 110 of the control device 100 in the second embodiment does not need to function as the connection control unit 112. The processor 210 of the main display device 200A in the second embodiment functions as the authentication request unit 211 and the connection control unit 212. The processor 210 of the auxiliary display device 200B functions as the authentication request unit 211, as in the first embodiment.

In the second embodiment, the auxiliary storage device 240 of the main display device 200A stores the display DB 141. The auxiliary storage device 140 of the control device 100 does not need to store the display DB 141.

In the second embodiment, the main display device 200A is an example of the connection control device.

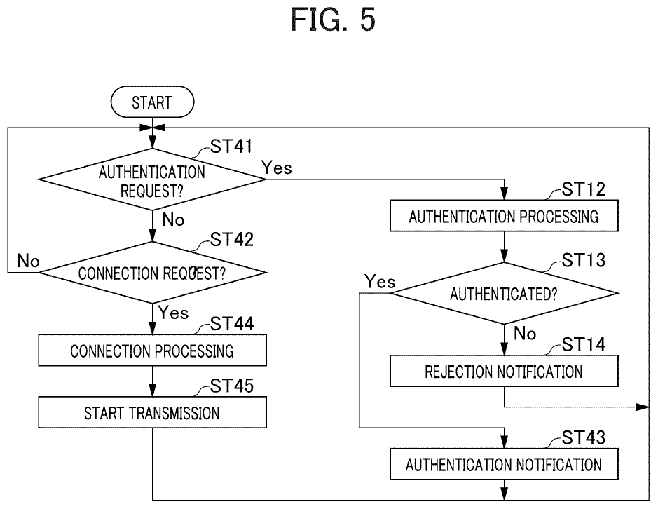

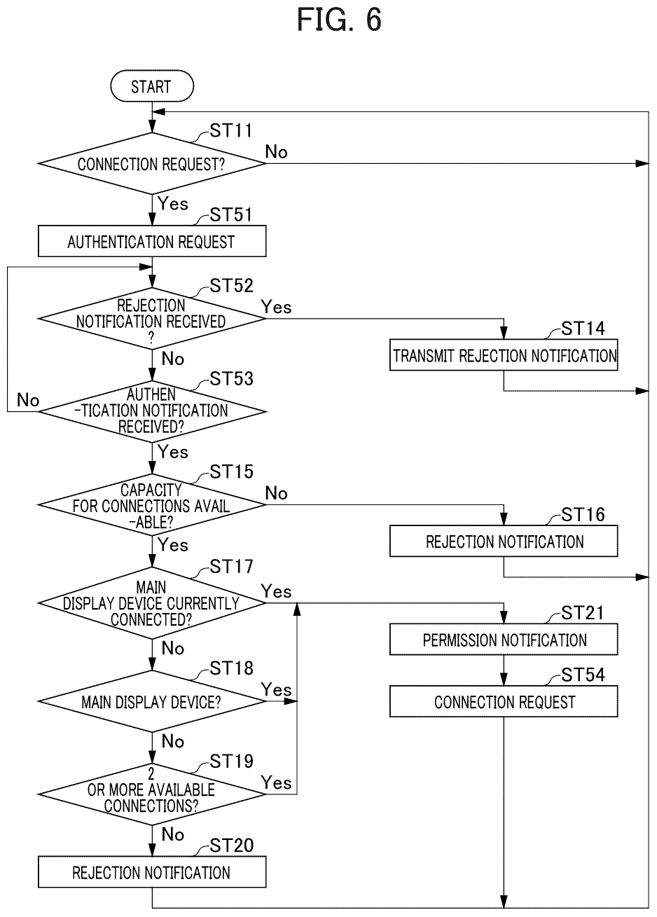

Next, the operation of the display system 1 according to the second embodiment will be described with reference to FIGS. 3, 5, and 6. The details of the processing described in the following operation are examples, and various processing capable of obtaining similar results can be used as appropriate. FIG. 5 is a flowchart illustrating an example of the processing by the processor 110 of the control device 100. The processor 110 executes the processing illustrated in FIG. 5, based on the programs stored in the ROM 120, the auxiliary storage device 140, or the like. FIG. 6 is a flowchart illustrating an example of the processing by the processor 210 of the main display device 200A. The processor 210 executes the processing illustrated in FIG. 6, based on the programs stored in the ROM 220, the auxiliary storage device 240, or the like. The display devices 200, both the main display device 200A and the auxiliary display device 200B, execute the processing illustrated in FIG. 3, as in the first embodiment. The main display device 200A executes the processing illustrated in FIGS. 3 and 6 in parallel or sequentially.

In the second embodiment, in Step ST32 illustrated in FIG. 3, the processor 210 of the display device 200 transmits the first connection request to the main display device 200A instead of the control device 100. In Step St 32, the processor 210 of the main display device 200A transmits the first connection request to the processor 210 itself by using a loopback address. Alternatively, the processor 210 of the main display device 200A may, instead of transmit, input the first connection request into the program executing the processing illustrated in FIG. 6. The processor 210 of the main display device 200A similarly transmits or inputs other information to the processor 210 itself.

In the second embodiment, instead of the processor 110 of the control device 100, the processor 210 of the main display device 200A executes the processing in Steps ST11 and ST15 to ST21 illustrated in FIG. 6. However, the “communication interface 150” in the description of the processing in Steps ST11 and ST15 to ST21 in the first embodiment is read as the “communication interface 250” in the second embodiment.

In the second embodiment, if the processor 210 determines Yes in Step ST11, the processing proceeds to Step ST51.

In Step ST51, the processor 210 generates an authentication request. The authentication request includes the login ID and password contained in the first connection request received in Step ST11. The authentication request is information that requests the control device 100 to execute authentication using the login ID and password. After generating the authentication request, the processor 210 instructs the communication interface 150 to transmit the authentication request to the control device 100. Upon receiving the transmission instruction, the communication interface 150 transmits the authentication request to the control device 100. The transmitted authentication request is received by the communication interface 250 of the control device 100.

Meanwhile, in Step ST41 illustrated in FIG. 5, the processor 110 of the control device 100 determines whether an authentication request has been received by the communication interface 150. If an authentication request has not been received, the processor 110 determines No in Step ST41, and the processing proceeds to Step ST42.

In Step ST42, the processor 110 determines whether a second connection request has been received by the communication interface 150. If a second connection request has not been received, the processor 110 determines No in Step ST42, and the processing returns to Step ST41. Thus, the processor 110 remains in a waiting state, repeating Steps ST41 and ST42 until an authentication request or a second connection request is received.

If an authentication request is received while the processor 110 is in the waiting state of Steps ST41 and ST42, the processor 110 determines Yes in Step ST41, and the processing proceeds to Step ST12.

In the second embodiment, the processor 110 executes the authentication processing in Step ST12 using the login ID and password contained in the authentication request received in Step ST41.

In the second embodiment, if the processor 110 determines Yes in Step ST13, the processing proceeds to Step ST43.

In Step ST43, the processor 110 instructs the communication interface 250 to transmit an authentication notification to the main display device 200A that is the source of the authentication request. Upon receiving the transmission instruction, the communication interface 250 transmits the authentication notification to the main display device 200A. The transmitted authentication notification is received by the communication interface 150 of the display device 200. After the processor 110 executes the processing in Step ST43, the processing returns to Step ST41.

Meanwhile, in Step ST52 illustrated in FIG. 6, the processor 210 of the main display device 200A determines whether a first rejection notification has been received by the communication interface 250. If a first rejection notification has not been received, the processor 210 determines No in Step ST52, and the processing proceeds to Step ST53.

In Step ST53, the processor 210 determines whether an authentication notification has been received by the communication interface 250. If an authentication notification has not been received, the processor 210 determines No in Step ST53, and the processing returns to Step ST52. Thus, the processor 210 remains in a waiting state, repeating Steps ST52 and ST53 until a first rejection notification or an authentication notification is received.

If a first rejection notification is received while the processor 210 is in the waiting state of Steps ST52 and ST53, the processor 210 determines Yes in Step ST52, and the processing proceeds to Step ST14.

In Step ST14, the processor 210 may forward the first rejection notification received in Step ST52 to the display device 200. In Step ST14 illustrated in FIG. 5, the processor 110 may transmit the first rejection notification not only to the main display device 200A but also to the display device 200 that is the source of the first connection request. In this case, the main display device 200A does not execute the processing in Step ST14 illustrated in FIG. 6.

If an authentication notification is received while the processor 210 is in the waiting state of Steps ST52 and ST53, the processor 210 determines Yes in Step ST53, and the processing proceeds to Step ST15.

In the second embodiment, in Step ST18, if the display ID included in the first connection request received in Step ST11 is the display ID indicating the processor 210 itself, the processor 210 may determine that the display device 200 that is the source of the first connection request is the main display device 200A. The display ID presenting the component itself is, for example, a loopback address. If the display ID included in the first connection request is not the display ID indicating the processor 210 itself, the processor 210 may determine that the display device 200 that is the source of the first connection request is the auxiliary display device 200B.

After the processor 210 executes the processing in Step ST21, the processing proceeds to Step ST54. In Step ST54, the processor 210 instructs the communication interface 150 to transmit a second connection request to the control device 100. The second connection request includes information identifying the display device 200 that is the source of the first connection request. The second connection request is information requesting the establishment of connections with the display device 200. This information includes, for example, the display ID or IP address of the source. Upon receiving the transmission instruction, the communication interface 150 transmits the second connection request to the control device 100. The transmitted second connection request is received by the communication interface 250 of the control device 100. After the processor 210 executes the processing in Step ST54, the processing returns to Step ST11.

The processing in Steps ST15 to ST21 and Step ST54 illustrated in FIG. 6 is executed, for example, by the connection control unit 212. By executing the processing in Steps ST17 to ST21, in a case where a connection request from the first device to the second device is received, and the first device is not a device of the first type, if there are (2-(the number of the first devices of the first type that have established connections with the second device)) or more available connections, the processor 210 functions as an example of the connection control unit that permits the connection with the second device, and rejects the connection with the second device if it is not the case. By executing the processing in Step ST18, the processor 210 functions as an example of the determination unit that determines that the first device is a device of the first type among the plurality of types.

If a second connection request is received while the processor 110 is in the waiting state of Steps ST41 and ST42, the processor 110 determines Yes in Step ST42, and the processing proceeds to Step ST44.

In Step ST44, the processor 110 executes the processing of establishing connections with the display device 200 indicated by the second connection request received in Step ST42. The processor 110 collaborates with the display device 200 to establish the connection in the same manner as in Step ST22 illustrated in FIG. 2. That is, the control device 100 and the main display device 200A establish the connection between the control device 100 and the display device 200 through the processing in Step ST44 illustrated in FIG. 5 and Step ST36 illustrated in FIG. 3. Alternatively, the processor 110 may collaborate with both the display device 200 and the main display device 200A that is the source of the second connection request to establish the connection. The control device 100 may establish the connection with the display device 200 directly without the main display device 200A, or may establish the connection with the display device 200 through the main display device 200A. In this case, for example, connections are established between the control device 100 and the main display device 200A, and between the main display device 200A and the display device 200.

In Step ST45, the processor 110 starts transmitting video to the display device 200 indicated by the second connection request, using the established connection. The communication interface 150 transmits the video to the display device 200. The transmitted video is received by the communication interface 250 of the display device 200. The processor 110 may transmit the video to the display device 200 via the main display device 200A that is the source of the second connection request. That is, the communication interface 150 transmits the video to the main display device 200A. The transmitted video is received by the communication interface 250 of the main display device 200A. The main display device 200A, having received the video, then transmits the video to the display device 200. After the processor 110 executes the processing in Step ST45, the processing returns to Step ST41.

In the display system 1b of the second embodiment, as in the first embodiment, at least one main display device 200A can reliably connect to the control device 100. That is, the display system 1b of the second embodiment guarantees that a predetermined type of device, the main display device 200A, can connect to the control device 100.

According to the display system 1b of the second embodiment, the main display device 200A functions as the connection control unit 212. Thus, even in a case where the control device 100 does not function as the connection control unit 112, the display system 1b of the second embodiment can control the connection to ensure that at least one main display device 200A can reliably connect to the control device 100.

The second embodiment described above can be modified as follows. In the second embodiment, the main display device 200A reserves one of the available connections for the main display device 200A itself. However, the control device 100 may reserve two or more of the available connections for the main display device 200A. Generalizing, the main display device 200A reserves N of the available connections for the main display device 200A itself. In this case, in Step ST17, the processor 210 of the main display device 200A determines whether N main display devices 200A are currently connected. In Step ST19, the processor 210 determines whether there are (N+1-(the number of the main display devices 200A that have established connections with the control device 100)) or more available connections.

Thus, in a case where the display device 200 that requested the connection with the control device 100 is the auxiliary display device 200B, the display system 1 of the embodiment rejects the connection unless there are (N+1-(the number of the main display devices 200A that have established connections with the control device 100)) or more available connections with the control device 100. As a result, the display system 1 of the embodiment ensures that N main display devices 200A can reliably connect to the control device 100.

The processor 210 of the auxiliary display device 200B does not need to function as the authentication request unit 211. In this case, instead of the auxiliary display device 200B, the main display device 200A functions as the authentication request unit 211.

The above embodiments, namely the first and second embodiments, can be modified as follows. In the above embodiments, the display device 200 that has been authenticated in the authentication processing can connect to the control device 100. However, the authentication processing may be unnecessary.

The processor 210 of the main display device 200A may function as the authentication control unit. That is, instead of the control device 100, the main display device 200A may execute the authentication processing.

In the above embodiments, the display devices 200 can be classified into two types: the main display device 200A and the auxiliary display device 200B. However, the display devices 200 may be classified into a plurality of types in other ways. One of these types will be the first type of device. The number of types may be three or more.

In the above embodiments, the devices that connect to the control device 100 are display devices 200. However, the devices that connect to the control device 100 may be other types of devices instead of the display devices 200.

In the above embodiments, the control device 100 that controls the industrial machinery 300 has been described as an example of the connection control device of the embodiments. However, the connection control device of the embodiments is not limited to this. The connection control device of the embodiments may be a device that controls machines or devices other than industrial machinery, such as a PC (personal computer), server device, or other computer.

In the above embodiments, part of the processing executed by the control device 100 may be executed by the display device 200. In the above embodiments, part of the processing executed by the display device 200 may be executed by the control device 100. In the above embodiments, part of the processing executed by the main display device 200A may be executed by the auxiliary display device 200B. In the above embodiments, part of the processing executed by the auxiliary display device 200B may be executed by the main display device 200A.

The processor 110 and the processor 210 may implement part or all of the processing implemented by the programs in the above embodiments, by using the hardware configuration of the circuits.

The programs that implement the processing of the embodiments are transferred, for example, in a state stored on a non-transitory recording medium within the device. However, the device may be transferred without the programs stored therein. The programs may be transferred separately and written into the device. The transfer of the programs can be implemented, for example, by recording the programs on a removable non-transitory storage medium or by downloading the programs via a network such as the Internet or LAN.

The embodiments of the present invention have been described above as examples and do not limit the scope of the present invention. The embodiments of the present invention can be implemented in various forms without departing from the essence of the present invention.

### EXPLANATION OF REFERENCE NUMERALS

1, 1b: display system
100: control device
110, 210: processor
111: authentication control unit
112: connection control unit
120, 220: ROM
130, 230: RAM
140, 240: auxiliary storage device
141: display DB
142: login DB
150, 250: communication interface
160: control interface
170, 280: bus
200: display device
200a: main display device
200b: auxiliary display device
211: authentication request unit
260: display device
270: input device
300: industrial machinery

1. A connection control device, comprising:
a determination unit that determines that a first device is a device of a first type among a plurality of types; and
a connection control unit, wherein, in a case where a connection request to a second device is received from the first device, and the first device is not a device of the first type, the connection control unit permits connection to the second device if there are (N (where Nis an integer of 1 or more)+1-(a number of the first devices of the first type that have established connection with the second device)) or more available connections, or the connection control unit rejects the connection to the second device otherwise.

2. The connection control device according to claim 1, wherein the connection control device is the second device.

3. The connection control device according to claim 1, wherein the connection control device is the first device of the first type.

4. The connection control device according to claim 1, wherein N is 1.

5. A connection control system comprising:
a connection control device and a display device, wherein
the connection control device includes:
a determination unit that determines that the display device is the display device of a first type among a plurality of types; and
a connection control unit, wherein, in a case where a connection request to a second device is received from the display device, and the display device is not the display device of the first type, the connection control unit permits connection to the second device if there are (N (where N is an integer of 1 or more)+1-(a number of the display devices of the first type that have established connection with the second device)) or more available connections, or the connection control unit rejects the connection to the second device otherwise, wherein
the display device includes:
a receiving unit that receives video transmitted from the second device connected to the display device; and
a display unit that displays the video.

6. A non-transitory computer-readable medium storing a program that causes a processor included in a connection control device to function as:
a determination unit that determines that a first device is a device of a first type among a plurality of types; and
a connection control unit, wherein, in a case where a connection request to a second device is received from the first device, and the first device is not a device of the first type, the connection control unit permits connection to the second device if there are (N (where N is an integer of 1 or more)+1-(a number of the first devices of the first type that have established connection with the second device)) or more available connections, or the connection control unit rejects the connection to the second device otherwise.
